(19) United States
(12) Patent Application Publication
(10) Pub. No.: US 2013/0055105 A1
(43) Pub. Date: Feb. 28, 2013

(54) Electronic Message Management System and Method

(71) Applicant: Mitchell D. Spierer, San Francisco, CA (US)

(72) Inventor: Mitchell D. Spierer, San Francisco, CA (US)

(21) Appl. No.: 13/659,736

(22) Filed: Oct. 24, 2012

Related U.S. Application Data
(62) Division of application No. 12/814,205, filed on Jun. 11, 2010.

(51) Int. Cl. G06F 15/16; G06F 3/01; G06F 3/048

(52) U.S. Cl. 715/752; 709/206; 715/835

(57) ABSTRACT

Embodiments of the invention relate to the creation of electronic message handling rules and to the creation of groups of electronic message recipient addresses. An automatic creation of electronic message rules or filters is dynamically based upon routine user actions or inputs that can have purposes other than only for the creation of rules. According to an embodiment, upon the movement of an email from one directory to any one of a plurality of other directories, a user is provided with one or more options for creating rules that will automatically move other emails to that same directory if they meet the selected criteria. With respect to the creation of groups, embodiments include the creation of groups that can occur as an electronic message is being composed.

### CROSS REFERENCE TO RELATED APPLICATIONS

This application is a divisional of, and claims the benefit of priority from, U.S. application Ser. No. 12/814,205, entitled “Electronic Message Management System and Method”, filed on Jun. 11, 2010, which such application is incorporated herein by reference in its entirety.

### FIELD OF INVENTION

This relates to a computer system, and more particularly, to methods, systems and computer program products for organizing electronic messages and for facilitating the generation of new electronic messages.

### BACKGROUND

Electronic message systems allow a user a certain degree of organizational flexibility with regard to incoming messages once they have arrived in a system's inbox or folder. Often, this organization relies on information associated with a message. For example some systems can sort incoming messages according to their arrival date and time.

Some systems include separate folders for storing incoming and outgoing messages. Also included may be a “Trash” folder where messages can be transferred if a user wants them to be deleted. Moreover some systems also allow the user to define additional folders for the organization and storage of messages in a similar manner as the folders for the trash, incoming and outgoing messages.

For example, the user might define separate folders for categories of people, companies, organizations, etc. with whom he or she regularly communicates, as well as folders for subject matter categories. Messages received from and sent to these people and entities, and messages dealing with a particular subject matter can be organized and stored in these separate, user-defined folders.

Electronic messages can be moved from one folder to another manually using various commands, including so-called “drag-and-drop” operations that are executed for example with a computer mouse or with a touch screen interface. Also in some systems, the user can create a rule or filter for automatically transferring messages from one mailbox or folder to another. A rule operates as part of the systems' programming and executes in response to the users' defined filter parameters. For example, an automatic transfer of a message from an inbox to a trash folder might be invoked by the presence of particular data, such as a user-defined character string, in the message's “sender” field or “subject” field, etc. When an incoming message arrives, it is compared to the defined filters or rules to determine if any type of transfer should be performed.

In addition to user-defined rules, some systems include features to facilitate the creation of a new message. These systems typically present the user with a display of a blank message form having a plurality of fields into which the user can enter data, such as text and recipients, as part of the email creation process. These message fields can include a sender field, an addressee or recipient field, a subject field, a message body field, etc.

One feature to facilitate electronic message creation is a user-defined, addressee group feature. When a user anticipates that he/she frequently will be sending messages to the same group of addressees, some systems permit the user to create a single addressee group that includes a plurality of addresses. When the user desires to send a new message to these same addressees, he/she can enter the single group name in the addressee field of the displayed message form, and the system will automatically populate that field with the addresses.

However, while existing electronic message systems, methods and software products may be functionally adequate, there is room for improvement. As the volume of email continues to increase, there is a need to improve the speed and ease with which certain message system functions can be performed, so that a user can perform his/her tasks more efficiently.

### SUMMARY OF THE ILLUSTRATED EMBODIMENTS

Broadly speaking, certain embodiments of the invention relate to the automatic creation of electronic message rules or filters. Their creation is dynamically based upon routine user actions or inputs that can have purposes other than only the creation of rules. For example upon the movement by a user of an email from one folder or directory to any one of a plurality of other directories (including directories created by the user), the user is provided with one or more single action options for creating rules that will automatically move other emails to that same directory if they meet the selected criteria. Alternative embodiments relate to the automatic creation of groups, such as for example groups of electronic message recipient addresses. For example the creation of groups can occur with a single click or other single user action while an electronic message is being composed.

In one embodiment, a first message is received. The first message is an electronic message having data in a first message first field and is associated with a first directory, for example an inbox. Next, the first message is associated with a second directory in response to a user input. A first command icon is presented on a user interface in response to the user input. The first command icon corresponds to a command for the creation of a first rule for automatically associating other messages with the second directory if they have data in at least one of a plurality of the other messages' fields that is the same as at least a portion of the data in the first message first field. A selection by the user of the first command icon is received, the selection being only a single action performed by the user. The first rule is created in response to the selection by the user of the first command icon. A second message is automatically associated with the second directory in response to an execution of the first rule.

In an alternative embodiment a user is provided with access to a first recipient field of a first electronic message. An input by the user of a plurality of addresses in the first recipient field is received. Then a selection by the user of a group command is received after the inputting of the plurality of addresses. The group command corresponds to a command to create an addressee group comprised of the plurality of addresses. A first input by the user of a group name for the addressee group is received. The addressee group is created in response to the selection by the user of the group command and is stored in a memory.

In another aspect, the group command is presented to the user in response to the input by the user of the plurality of addresses in the first recipient field. The presenting of the group command to the user includes for example one of activating on a display an icon associated with the group command, and displaying on the display the icon associated with the group command, and providing a machine-generated voice prompt associated with the group command.

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1 is a simplified block diagram of an electronic message management system to which embodiments of the invention may be applied;

FIGS. 2a-2e are user interface displays of a system for the creation of an electronic message rule in accordance with an embodiment of the invention;

FIG. 3 is a simplified process flow diagram of a method for the creation of an electronic message rule in accordance with another embodiment of the invention;

FIGS. 4a-4g are user interface displays of a system for the creation of a recipient group for use in connection with electronic messages in accordance with another embodiment of the invention; and

FIG. 5 is a simplified process flow diagram of a method for the creation of an electronic message recipient group in accordance with another embodiment of the invention.

### DETAILED DESCRIPTION

The following description is of the best mode presently contemplated for carrying out the invention. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention.

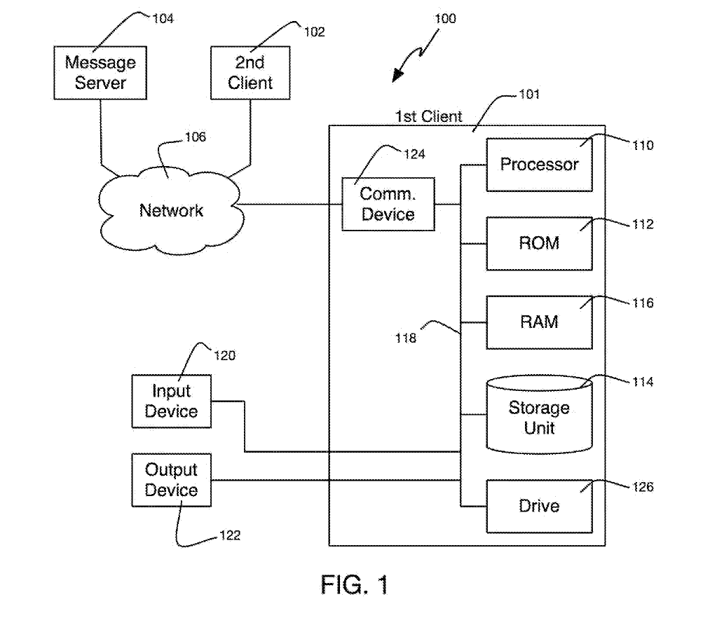

Referring to FIG. 1, there is shown an exemplary configuration of an electronic message management system 100 to which embodiments of the present invention may be applied. The management system 100, which is configured to send, receive, store, organize and generate electronic messages (such as, for example, electronic mail or email), is comprised of a first client 101, a second client 102 and a message server 104. The message server 104 and the second client 102 are each connected or coupled to the first client 101 and to each other via a network 106 which is the Internet for example. In this example, only two clients and one message server are shown, but those skilled in the art will appreciate that any number of clients and servers may be connected to the network 106.

The message server 104 provides mail or electronic message relay functions for transferring electronic messages from one client to another, sometimes via other message servers. An example of a common protocol for handling at least some of these functions is the Simple Mail Transfer Protocol (SMTP). While the message server 104 can use SMTP to send and receive emails, the first and second clients 101, 102 employ applications that typically only use SMTP for sending messages to the message server 104 for relaying. For receiving messages, the first and second clients 101, 102 of this embodiment frequently use either the Post Office Protocol (POP) or the Internet Message Access Protocol (IMAP) to access their message accounts on the message server 104.

The first client 101 includes a central processing unit (CPU) or processor 110 configured to execute a variety of processing operations as directed by programs and applications stored in a read-only memory (ROM) 112 or loaded from a storage unit 114 into a random access memory (RAM) 116. The processor 110, the ROM 112, the RAM 116 and the storage unit 114 are coupled or interconnected via a bus 118. The storage unit 114 includes a non-transitory, computer-readable storage medium and is for storing relatively large quantities of data, applications, etc. The storage unit 114 can be one or more hard disk drives, flash memory devices, etc. The RAM 116 also stores data and so on necessary for the processor 110 to execute a variety of applications and processing operations as required. The ROM 112, the RAM 116 and/or the storage unit 114 stores operating software and applications that are used along with the processor 110 to enable the operation of the first client 101.

The system 100 further includes at least one input device 120, such as for example, a keyboard and a mouse, a microphone for receiving voice or other sound input, a sensor for detecting motion, a pointing device, a touch screen display, or a remote-controlled wireless input unit, such as for example a television remote control-type unit. Alternative embodiments can include any combination of the foregoing types of input devices, as well as other input devices. Thus the system 100 permits user input via a user action that includes clicking a mouse button when a cursor is positioned over a pre-defined area of an output device 122, such as for example a display unit based upon a LCD. (The output device 122 can further include a speaker for providing voice prompts and spoken words, music and system tones.) Other user actions for input can include a generation by the user of a sound or movement, a selection using the television-type remote control unit, a depressing of a key on the keyboard, a movement of the pointing device or a touching on the touch screen display with the pointing device or with the user's finger, or a selection of a displayed indication.

The bus 118 further couples or connects the input device 120, the output device 122, the storage unit 114, and a communication device 124. The communication device 124 can be a modem, a network interface card (NIC), a wireless access card or adapter, or other terminal adapter, for example. The communication device 124 executes communication processing via the network 106, sends data supplied from the processor 110, and outputs data received from the network 106 to the processor 110, the RAM 116, and the storage unit 114. The communication device 124 also communicates analog signals or digital signals with other clients.

The bus 118 is also connected or coupled to a drive 126 as required on which a non-transitory, computer-readable storage medium, such as a magnetic disk, an optical disk, a magneto-optical disk, or a semiconductor memory for example, is loaded with computer applications containing instructions or with other data read from any of these storage media. These instructions and data, when executed by the processor 110, cause it to perform a plurality of methods or functions.

Although not shown in detail, the message server 104 and the second client 102 are also each configured as a computer that has a generally similar configuration as that of the first client 101. While FIG. 1 shows one configuration of the first client 101, alternative embodiments include a set top box, a personal computer, a cellular phone, a so-called “smart” phone, a portable digital assistant, and any other type of a computer or processor-driven device. Also while FIG. 1 generally has been described in connection with emails, alternative embodiments include systems for other types of electronic messages, such as for example, SMS messages, chat messages, text messages, multimedia messages, voice and voicemail messages, electronic document transfers, data transfers, cloud hosted messages, etc. The forms of such electronic messages are virtually limitless and can further include audio, video, electronic text, electronic graphics, and/or any combination thereof.

As previously mentioned, embodiments of the invention provide for the automatic creation of electronic message rules or filters. The creation of the rules is dynamically based upon routine user actions or inputs that can have purposes other than only the creation of rules. Thus, user attention to rule creation is not required until later in the process as compared with conventional systems. Conventional systems for example frequently require the user to first choose to create a rule, then select the criteria for the rule, and then select a destination directory for placement of those electronic messages that satisfy the criteria. Such systems are typically complex and time consuming to use, and require many user operations or commands. On the other hand, embodiments of the invention do not require the user to make a decision to create a rule at the outset in order to begin the rule creation process. Rather, the dynamic nature of the system follows normal user action, such as for example the moving of an email from one folder or directory to any one of a plurality of other folders or directories (including those created by the user), and then provides one or more single-click or other single action options for creating rules that will automatically move other emails to that same directory if they meet the selected criteria.

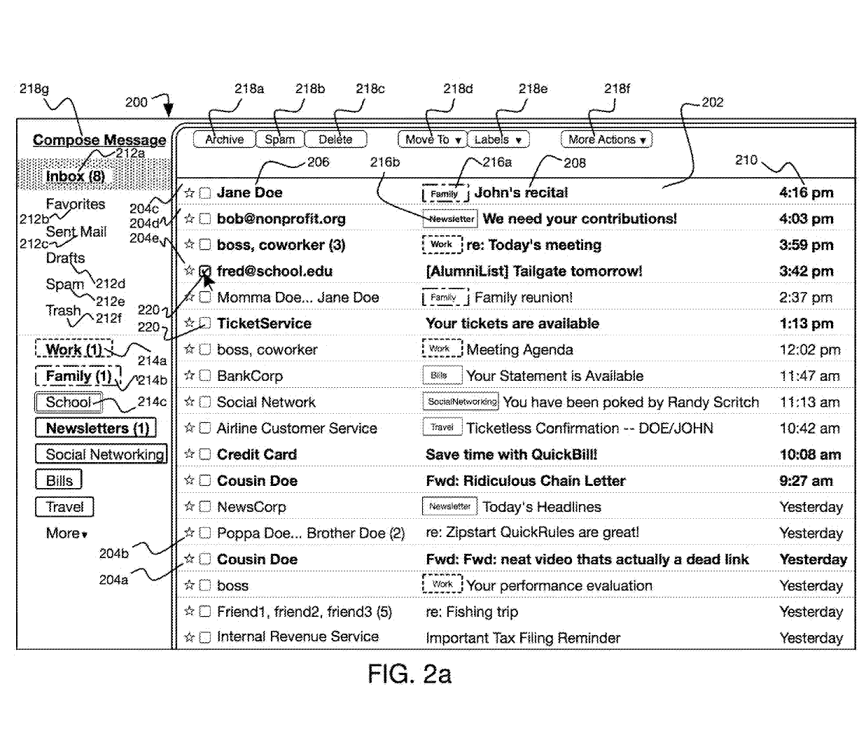

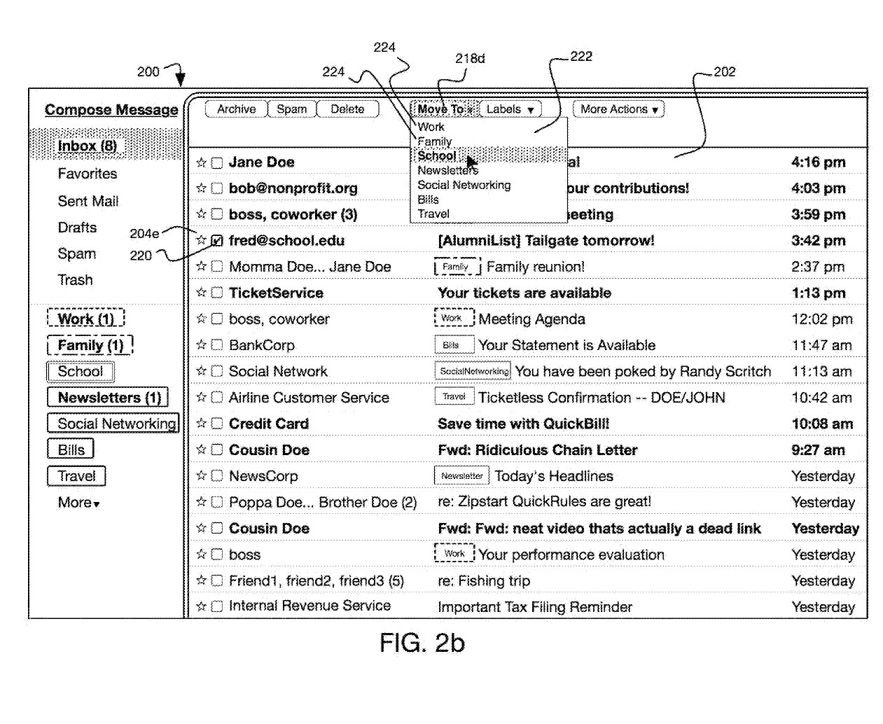

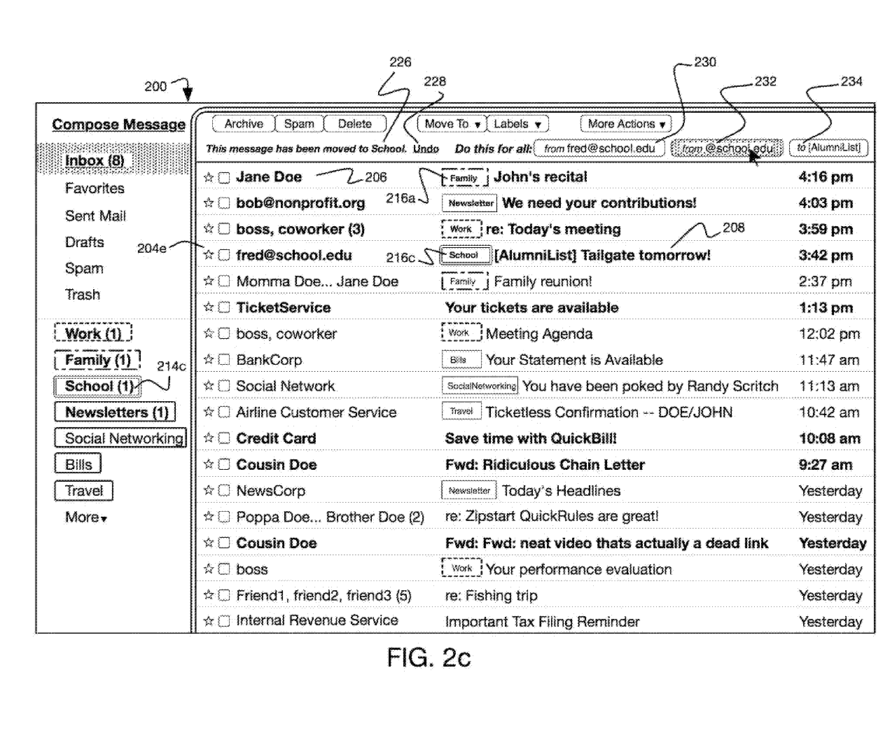

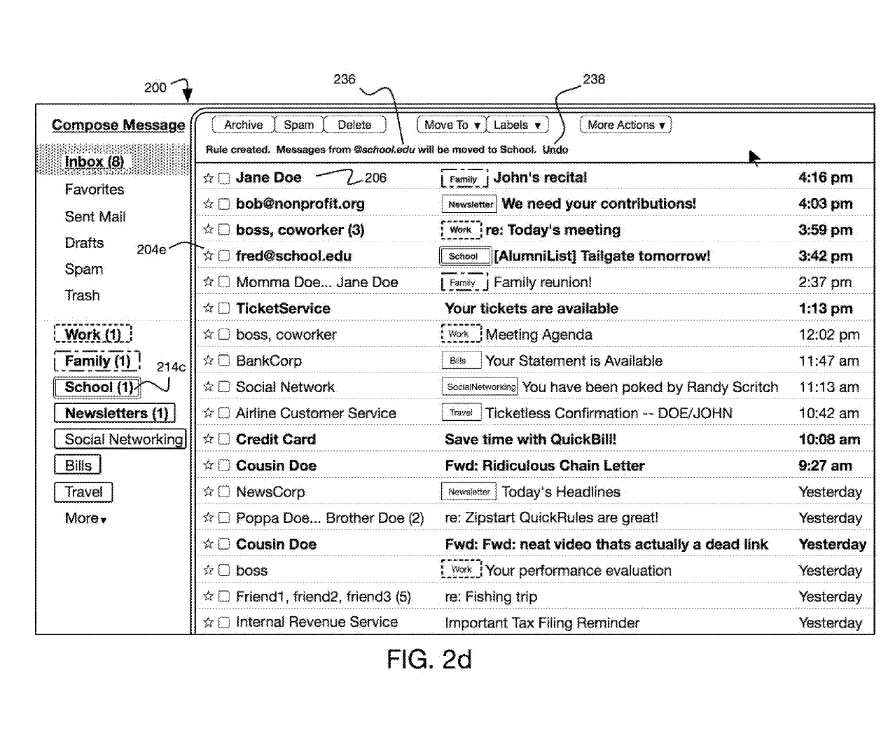

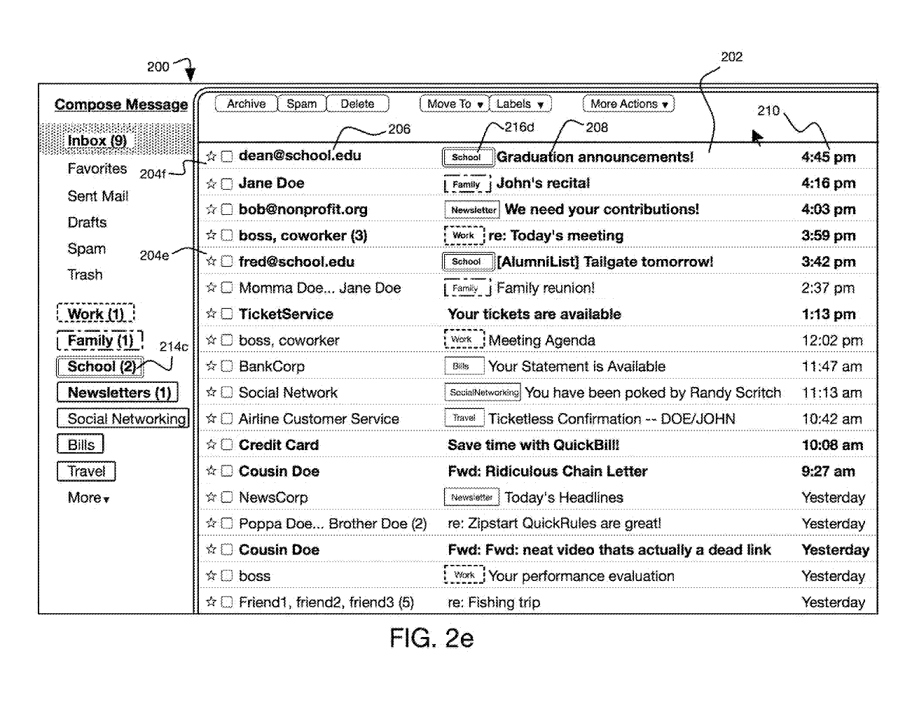

FIGS. 2a-2e depict a user interface portion of a system for the creation of electronic message rules in accordance with an embodiment of the invention. The user interface is a display 200 portion of a user output device, such as for example, a computer monitor. Referring first to FIG. 2a, the display 200 includes a summary listing 202 of a plurality of electronic messages, which in this embodiment are emails, such as those designated by reference numerals 204a-204e. The summary listing 202 only shows limited information about each email, and thus this view depicts information from a limited number of email fields. In this case information or data from an email sender field 206, a subject field 208 and a time received field 210 is displayed for each of the plurality of emails 204a-204e. If a user desires to view information from additional email fields for any given email then that email can be selected and opened, thereby providing another view (not shown in FIG. 2a) of a plurality of additional fields, including for example a message body field containing the full text of the email message body, recipient fields for data related to one or more recipient email addresses, a message attachment field for data relating to any attachments that are a part of the email, and a message tag field for data that correspond to one or more tags associated with the email. Located adjacent to the sender field 206 of each email is an email selection check box 220. By entering a “check” mark in one or more check boxes 220, the user can designate those emails for which a follow up action is to be taken as described more fully below. An example of a selected email is the email designated by reference numeral 204e which has associated therewith the check box 220 containing a check mark.

Emails that have not yet been opened are shown in a bold font. An example of such an unopened email is that designated by reference numeral 204c. Emails that previously have been opened are shown in regular font such as, for example, the email that designated by reference numeral 204b. In alternative embodiments unopened emails can be displayed with a background of one color or shade, whereas previously-opened emails can be displayed with a background of a different color or shade.

The display 200 further includes a plurality of email system-default folder icons or links 212a-212f for use in assisting the user in organizing and storing or associating emails. These system-default folder links include an Inbox folder link 212a, a Favorites folder link 212b, a Sent Mail folder link 212c, a Drafts folder link 212d, a Spam folder link 212e, and a Trash folder link 212f. Also included are a plurality of user-defined folder icons or links 214a-214c for use in further assisting in the organizing and storing of emails. The user-defined folder links 214a-214c are for email directories or folders that are created and named by the user, which in the illustrated embodiment include folder links such as a “Work” folder link 214a, a “Family” folder link 214b, a “School” folder link 214c, as well as others.

Those directories or folders containing emails that have not yet been opened by the user include a numeral located adjacent to the folder link, where the numeral corresponds to the number of emails that have not yet been opened. For example the system folder link “Inbox” 212a has the numeral “8” located adjacent to this link, thus indicating that the “Inbox” folder has eight (8) emails that have not yet been opened by the user, although there are additional emails in that folder that have been opened.

The summary listing 202 of FIG. 2a identifies all of the emails 204a-204e in the system, and they are displayed in this listing regardless of the directory or folder to which each email is associated or in which it is otherwise stored. For those emails which are associated with or stored in one of the user-defined folders, folder labels 216a-216b are disposed adjacent to the subject field 208 of that email. For example the email designated by reference numeral 204c has a folder label 216a with the title “Family.” This indicates that the email 204c is associated with or otherwise stored in the user-defined folder “Family” that in turn is associated with the “Family” link 214b. (For further ease of use, embodiments can include a color coding scheme whereby the user-defined folder links 214a-214c are displayed in various colors that match the colors of the corresponding folder labels 216a-216b or, in an embodiment without labels, the color could be reflected in the message itself) Should the user select the “Family” folder link 214b, then the display 200 would change to show a summary listing of only the emails associated with the “Family” folder. The system operates in a similar manner with respect to the selection of any of the other system folder links 212a-212f or the other user-defined folder links 214a-214c.

Still referring to FIG. 2a, arrayed along the top of the display 200 is a plurality of command links or icons 218a-218g. The command icon labeled “Archive” 218a is for the execution of a system command to move one or more emails 204a-204e that have been selected to an archive or storage location in the system. The command icon labeled “Spam” 218b is for the movement of selected emails to a system folder associated with the “Spam” folder link 212e. The command icon “Delete” 218c is for the movement of selected emails to a system folder associated with the “Trash” folder link 212f. The command icon “Move To” 218d provides a drop down box (not shown in FIG. 2a) for the selection of one of the system or user-defined folders and for the movement of selected emails to the selected folder. The command icon “Labels” 218e provides another drop down box (not shown) for the selection of the existing folder labels 216a-216b (or for the creation of new folder labels) to appear in the summary listing 202 adjacent to the subject fields 208 of the selected emails. The command icon “More Actions” 218f provides yet another drop down box (not shown) for the selection of one of a plurality of other commands for operation on one or more selected emails. These other commands or actions might include for example: (a) a reply command for the displaying of an email form that automatically is addressed to the sender of the selected email and that optionally includes data taken from the subject and message body fields of the selected email; (b) a forward command for the displaying of an email form with a blank addressee field but that includes data taken from the subject and message body fields of the selected email; (c) a favorite command that associates a message with the Favorites folder link 212b and (d) a save attachment command for the downloading and storage of any attachment that is associated with the selected email, etc. The command link “Compose Message” 218g causes the system to display a blank email form having a plurality of blank fields for completion by the user when he/she desires to generate a new email.

Having now described the layout and function of certain components of the display 200, a description of the operation of the system for the creation of electronic message rules in accordance with the illustrated embodiment follows. First, a user moves an email from one folder or directory to (or associates an email from one folder or directory with) any one of a plurality of other directories or folders, including those created by the user. Referring to FIG. 2b, it can be seen that in this example the user has selected the email shown at reference numeral 204e by having inserted a check in the associated check box 220. In this figure, the email 204e is associated with the “Inbox” folder. Also, the user has selected the “Move To” command icon 218d which caused the system to display the drop down box 222 that provides a plurality of movement command links or icons 224 for the linking of the selected email 204e with a selected folder, which in the illustrated embodiment is the folder designated “School” as selected by the user. (This linking for example can include moving the email from the folder to which it currently is associated or stored to a selected folder, severing the email's association with the current folder and associating it with a new folder, adding an association with a new folder in addition to the email's current associations, etc.) While this completes the actions necessary to link or move the email 204e in the illustrated embodiment, alternative embodiments include other actions and commands for associating emails with directories, including the so-called “drag and drop” method.

FIG. 2c illustrates the results of the commands previously described. After the user has moved the email 204e to (or associated it with) the user-defined folder that is designated “School,” the display 200 is automatically modified to that shown in FIG. 2c without requiring any further command entered or action taken by the user. A confirmation message 226 is shown that states that the email 204e has been moved to (or associated with) the “School” folder. Adjacent to the confirmation message 226 is an “Undo” command link or icon 228 to reverse the email movement process by reversing the command to associate the email 204e with the “School” folder and returning it to its previous state, which in this example was an association with the “Inbox” folder. Further confirmation that the email 204e has been moved to (or associated with) the “School” folder is the numeral “1” that now appears adjacent to the “School” user-defined link 214c, since in this case the email 204e had not yet been opened by the user. Yet further confirmation of the movement of the email 204e is the appearance of a folder label 216c which is disposed adjacent to the subject field 208 and which bears the word “School.”

The automatic modification of the display 200 further includes the presentation of a plurality of additional command icons or links. A first rule command icon 230 is labeled “from fred@school.edu” and is for the automatic creation or generation of a system rule that would automatically move or link all future emails (and optionally all existing emails associated with the “Inbox” folder) to the “School” folder if they have sender fields containing data that is the same as or corresponds to the address “fred@school.edu”—an address that appeared in the sender field 206 of the originally-selected email 204e. A second rule command icon 232 is labeled “from @school.edu” and is for the automatic generation of a system rule that would automatically move or link all future emails (and optionally all existing emails associated with the “Inbox” folder) to the “School” folder if they have sender fields containing data that is the same as or corresponds to the address portion “@school.edu”—a portion of the address that appeared in the sender field 206 of the originally-selected email 204e. Thus with this rule, emails from a plurality of different senders would all be automatically associated with the “School” folder so long as the email sender fields included the partial address “@school.edu.” A third rule command icon 234 is labeled “to [AlumniList]” and corresponds to a system rule that would automatically move or link all future emails (and optionally all existing emails associated with the “Inbox” folder) to the “School” folder if they have subject fields containing data corresponding to the text “[AlumniList]”—a portion of the text that appeared in the subject field 208 of the originally-selected email 204e. For sake of illustration of the operation of this embodiment, it can be seen in FIG. 2c that the user has selected the second rule command icon 232.

Thus it can be seen that the first, second and third rule command icons 230, 232, 234 and their respective system commands and functions are based upon an earlier email movement action by the user. Note that this action has a purpose other than only for the creation of a rule. These automatic rule-creation commands, if selected by the user, not only automatically take data from certain fields of the email (that was moved by the user) as criteria for use in comparison with other emails, but also automatically generate transfer functions (to be incorporated into the rules) for moving (or associating) the other emails to the same location as the earlier email.

While the embodiment of FIG. 2c involves the presenting of the first, second and third rule command icons 230, 232, 234 in the sense that they are made to be displayed for the first time in response to certain actions taken by the user as hereinabove described, alternative embodiments include presenting these icons in the sense of activating them. That is, such icons were previously displayed, but if not activated they are not placed in a condition to respond to a user selection of them and would not generate a system command if selected. An example of an activation of an icon includes displaying the icon in one color, shade or brightness when it is not activated (such as, for example, the so-called “graying out” of the icon) and displaying the icon in another color, shade or brightness when it becomes activated. Additionally while the illustrated embodiment uses icons, other embodiments for example may use voice prompts, menu fields, “shortcut” input commands such as specialized movements known to the user, etc.

FIG. 2d illustrates the result of the selection by the user of the second rule command icon 232. After the user has selected this command, the rule associated with the second rule command icon 232 (FIG. 2c) is created and made operative in response to only this single action that had been performed by the user including, for example, without any further command entered or action taken by the user. Moreover the display 200 generated by the system is automatically modified to that shown in FIG. 2d without any further command entered or action taken by the user. A confirmation message 236 is shown that states that the rule associated with the second rule command icon 232 (FIG. 2c) has been automatically created and that all messages with the data “@school” in the sender field 206 will be moved to the “School” folder. Adjacent to the confirmation message 236 is an “undo” command link or icon 238 for reversing the rule creation process by removing the previously-created rule associated with the second rule command icon 232. The modification of the display 200 further includes the removal of the first, second and third rule command icons 230, 232, 234 (FIG. 2c) so that they are no longer visible, although as previously stated the rule associated with the second rule command icon 232 exists and remains operative.

FIG. 2e illustrates the result of the operation of the rule that was created in connection with the description above for FIGS. 2b-2d. The summary listing 202 of FIG. 2e shows a new email 204f that was received by the system at the time shown in the time received field 210. Without any other command entered or action taken by the user, the rule automatically operated to move the email 204f to (or associate it with) the “School” folder. The sender field 206 of this email 204f includes the name “dean@school.edu.” While this name is associated with a different person sending the new email 204f than that of the earlier email 204e upon which the rule is based, the sender field of the new email 204f includes the common data portion “@school.edu” which triggered the operation of the rule. The operation of the rule and the automatic movement or association of the new email 204f with the “School” folder are confirmed by a folder label 216d located adjacent to the subject field 208 and bearing the name “School.” Further confirmation is seen by the numeral “2” located adjacent to the user folder link “School” 214c (previously there had been a numeral “1” at that location as illustrated in FIGS. 2c and 2d), since in this example the new email 204f has not yet been opened by the user.

The above description of the embodiment of FIGS. 2a-2e frequently refers to emails that are stored in one or more folders or directories and/or that are transferred from one folder or directory to another. However alternative embodiments involve other electronic message file formats and directory structures. Embodiments include associating an email with a directory whereby this associating can include storing the email, a copy of the email, or a link to the email within a directory (or folder), or alternatively tagging the email with a tag that links the email to that directory (or folder). Accordingly embodiments include folders and directories that comprise logical folder/directory views (and equivalents) as well as folders and subfolders that exist as part of one or more file structures (and equivalents).

The embodiment of FIGS. 2a-2e refers to the creation of a rule in response to only a single action performed by the user. (One example is a so-called single-click of a mouse button.) However, this reference to a single action may include a plurality of actions by the user within a short period of time. This plurality of actions may comprise one or more clicks of a mouse button, a right click followed by a left click of the mouse buttons, or one or more entries (or inputs) via other input devices. A single action by a user further may include multiple sub-elements that may be viewed as a single action, such as for example a double-click of a mouse button, or a modal shift on a keyboard, such as for example, a combination of a Control key or the Alt key with another key.

Also, while the embodiment of FIGS. 2a-2e refers to emails, alternative embodiments include other types of electronic messages, including for example, SMS messages, chat messages, text messages, multimedia messages, voice and voicemail messages, electronic document transfers, data transfers, cloud hosted messages, etc. The forms of such electronic messages are virtually limitless and can further include audio, video, electronic text, electronic graphics, and/or any combination thereof.

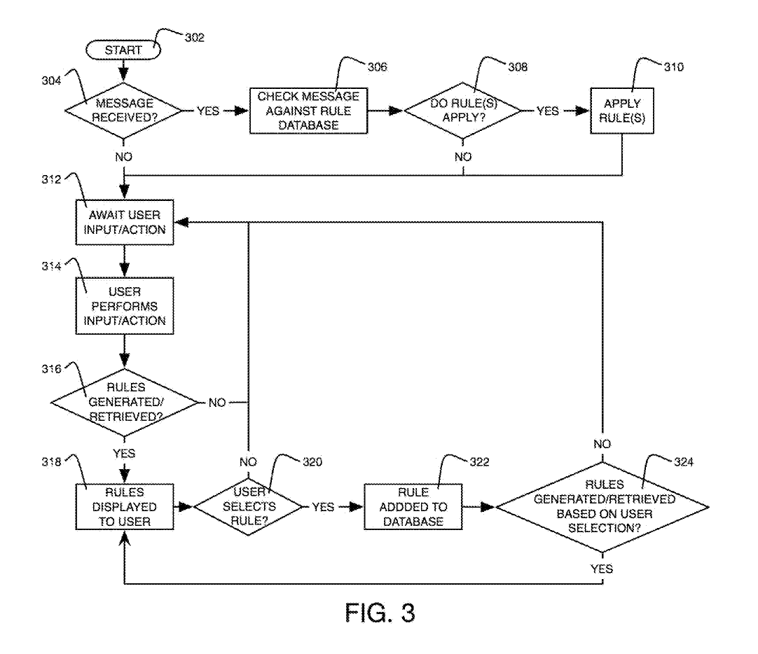

Referring now to FIG. 3, there is shown a simplified process flow diagram of a machine-implemented method for the creation of an electronic message management rule in accordance with an embodiment of the invention. The process starts at step 302 after which a determination is made as to whether a new electronic message, in this case an email, has been received. (Step 304) If a new email has been received, then it is compared against a rule database (Step 306) whereupon a determination is made as to whether any rules in the database are applicable to the new email. (Step 308) This comparison includes a review of data in at least one of a plurality of email fields including, for example, a sender field, a recipient field, a subject field, an attachment field, a tag field and a message body field. If there are one or more applicable rules, they are applied to the new email (Step 310) and the process flows to step 312 whereupon the system awaits user input or action. On the other hand if at step 308 it is determined that there are no applicable rules, then none are applied to the new email and the process flows to step 312 whereupon as previously mentioned the system awaits user input or action. Also returning to step 304, if on the other hand no new email has been received, then the process likewise flows to this same step 312.

Next, the user provides some system input or user action on an email. (Step 314) One example would be the movement of an email from one directory or folder (such as for example an Inbox folder) to another directory or folder (such as for example a user-defined folder). The system then makes a determination whether the user action in step 314 is the type of action for which an option for the automatic creation of a new rule should be generated or retrieved from a database. (Step 316) There may be some user actions, such as for example the forwarding of an email to another user, for which the system would not provide any automatic rule creation options. On the other hand there are other user actions, such as for example the moving of an email to a different folder, for which the system would provide one or more automatic rule-creation options. If the user action is not of the type for which an option to automatically create a new rule is to be provided, then the process returns to step 312 where the system awaits further user input or action. On the other hand if the user action is of the type for which an option to automatically create a new rule is to be provided, then the system displays one or more rule-creation command icons to the user. (Step 318)

At step 320 a determination is made as to whether the user selected one of the automatic rule-creation command icons. (Step 320) If no such command icon is selected then the process returns to step 312 whereupon the system awaits further user input or action. On the other hand if the user did select one of the rule-creation command icons, then the new rule is automatically created and added to the rule database in response to only this single action performed by the user such as, for example, without any further command entered or action taken by the user. (Step 322) Next, a determination is made as to whether any additional rule-creation command icons should be provided to the user (in addition to that selected in step 320), and whether there exist any rule-creation command icons previously presented to the user but not selected. (Step 324) If either condition is met, then the process proceeds to step 318 where the new rule-creation command icons, if any, and the previously presented rule-creation command icons, if any, are displayed to the user. On the other hand if neither condition is met, then the process returns to step 312 where the system awaits further user input or action.

Thus far there has been provided a detailed disclosure of embodiments generally relating to the dynamic creation of rules for the automatic association of electronic messages with directories selected by users. However alternative embodiments include systems and methods for the automatic creation of groups, such as for example groups of electronic message recipient addresses. Conventional systems provide the ability for users to create a group having multiple email addresses. However many such systems require multiple, cumbersome, manual steps by the user in order to create such groups. These steps include entering a command to commence the group creation process, creating a contact record for each email address to be added to the group (where such contact record had not previously been created and stored in the system), manually selecting from a list of contact records those that will be part of the group, generating a name for the group and saving the group to a system memory. Embodiments of the invention on the other hand provide for the dynamic creation of groups as an electronic message is being composed and with a single mouse click or other single user action.

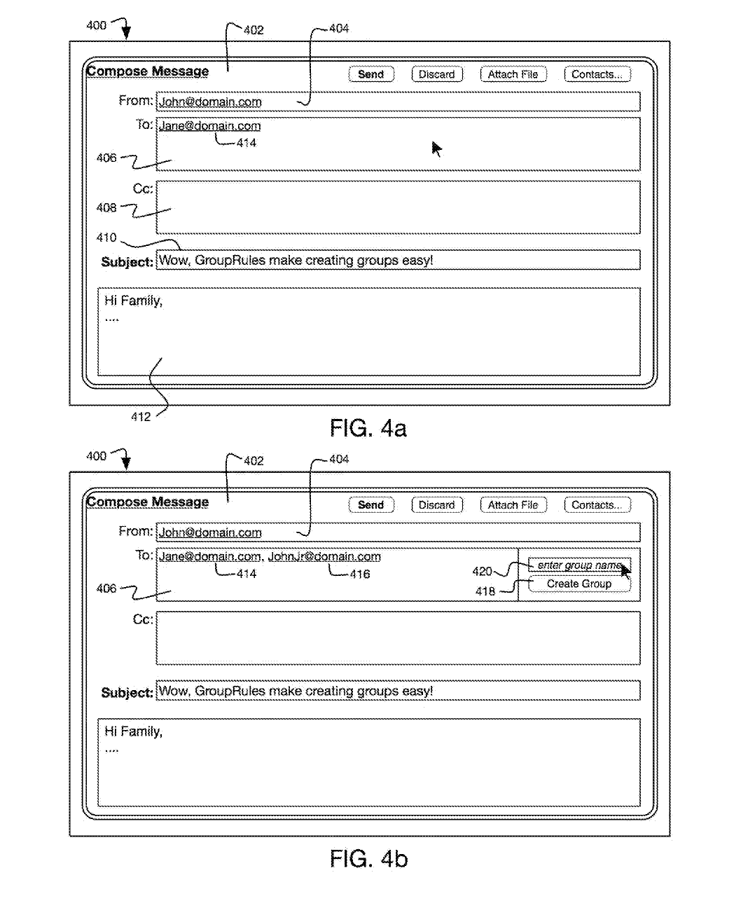

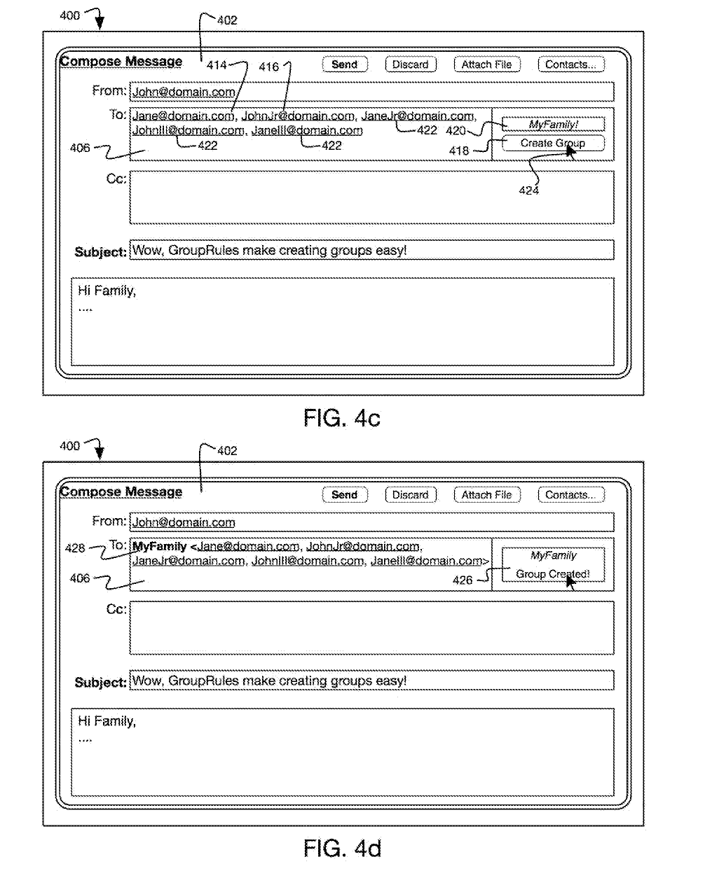

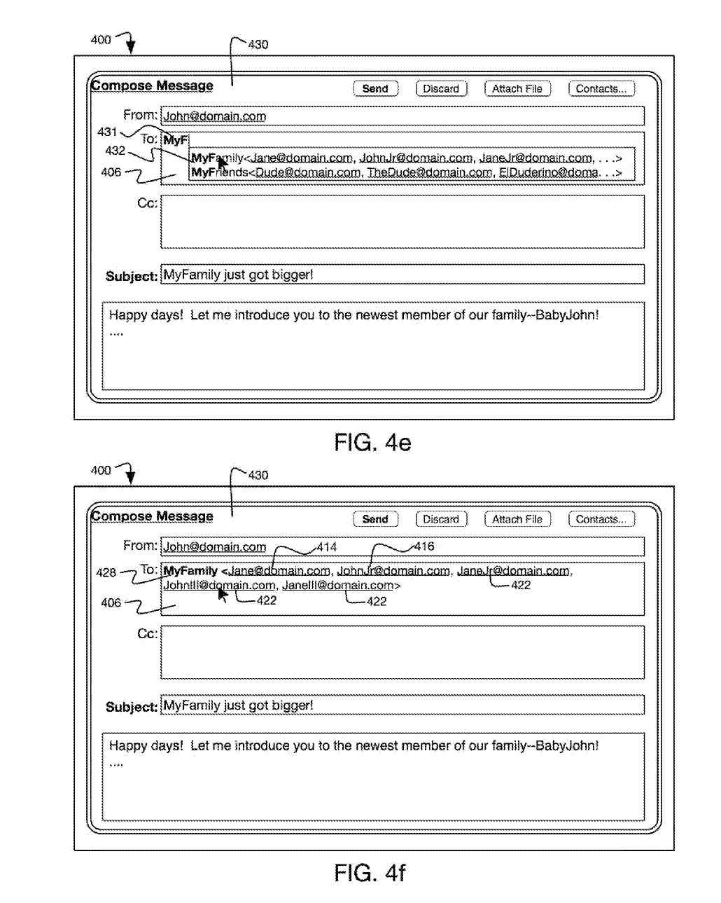

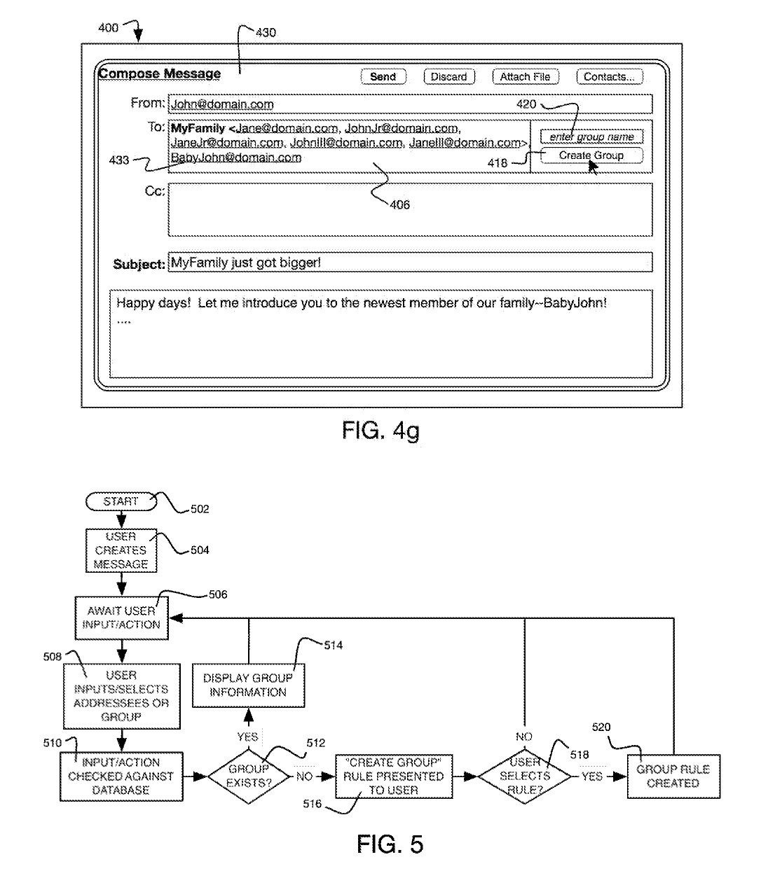

FIGS. 4a-4g depict a user interface portion of a system for the creation of groups for use in connection with electronic messages in accordance with an embodiment of the invention. The user interface is a display portion of a user output device, such as for example, a computer monitor. Referring first to FIG. 4a, a display 400 includes an electronic message form, which in this case is an email form 402 comprised of a plurality of fields. Thus, as is apparent by the layout of this email form 402, a user is provided with access to these fields so that in this embodiment the user may enter or input data or text in these fields as part of the process of composing an email message. The plurality of fields includes a sender field 404 into which data associated with the email address of the sender is placed; a recipient field 406 into which data associated with the email addresses of one or more direct recipients of the email is placed; a copied recipient field 408 into which data associated with the email addresses of one or more copied recipients of the email can be placed; a subject field 410 into which data associated with a text entry for the email subject can be placed; and a message body field 412 into which data associated with a text entry for the email message body can be placed. (In alternative embodiments other fields may include, for example, a blind-copied recipient field, a field for message tags and labels, a field for attachments, etc.) As is shown in FIG. 4a the user in this example has entered a first email address 414 in the recipient field 406.

Referring now to FIG. 4b, it can be seen that the user has entered in the recipient field 406 a second email address 416 that is different than the first email address 414. In response to this inputting of the second email address 416, the system automatically displays a first command link or icon 418 (i.e., a group command) and a text entry box 420. This occurs without any additional command or action taken by the user. As soon as the first command icon 418 and the text entry box 420 are displayed, the user can proceed with the automatic creation of a group addressee list (as will be described in further detail below) or the user can enter additional recipient email addresses or can input data in other fields. In the illustrated embodiment, the system presents the user with the group command by displaying the first command icon 418 on the display 400 for the first time. In alternative embodiments, the user is presented with the group command (a) by activating on the display 400 the first icon 418 that had been displayed (but not activated) prior to the inputting of the second email address 416, (b) by providing a machine-generated voice prompt associated with the group command, in lieu of or in addition to any visible icon or other representation of the group command, or (c) by allowing a user access to a menu containing the group command. Moreover while the illustrated embodiment presents the user with the group command prior to the sending of an email, alternative embodiments may present the group command after an email containing a plurality of email addresses has been sent.

In FIG. 4c it can be seen that, prior to the creation of any group list, the user in this example entered a plurality of additional email addresses 422 so that a total of five (5) email addresses are present in the recipient field 406. Moreover in the text entry box 420 the user has entered text corresponding to a name chosen by the user for the group list. In this example, the user input the name “MyFamily” and labeled this group with this name. Finally, the user selected the group command by placing a cursor 424 on the first command icon 418 and clicking a mouse button (not shown). In response to the selection of the group command, the system automatically creates a group comprised of the five (5) email addresses that are in the recipient field 406 and automatically stores the addressee group in a system memory. This automatic creating of the group and storing of it in the memory is accomplished by the system in response to only this single action performed by the user such as, for example, without the entering of any other command or the taking of any other action by the user. As seen in FIG. 4d, the automatic creation of the group is confirmed by the removal of the first command icon 418 and the text entry box 420 (that are shown in FIG. 4c, but not in FIG. 4d) from the display 400 and the displaying of a confirmation message 426 with text stating that the group has been created and that identifies the group name that was assigned by the user. Moreover for further confirmation, another appearance of the group name 428 is automatically displayed in the recipient field 406 adjacent to the five (5) email addresses along with brackets (“<” and “>”) encapsulating the group addresses.

The embodiment of FIGS. 4a-4c refers to the creation of a group in response to only a single action performed by the user. (One example is a so-called single-click of a mouse button.) However, as previously discussed this reference to a single action may include a plurality of actions by the user within a short period of time. This plurality of actions may comprise one or more clicks of a mouse button, a right click followed by a left click of the mouse buttons, or one or more entries (or inputs) via other input devices. A single action by a user further may include multiple sub-elements that may be viewed as a single action, such as for example a double-click of a mouse button, or a modal shift on a keyboard, such as for example, a combination of a Control key or the Alt key with another key.

FIGS. 4e-4g illustrate the operation of the system after the group has been created. Referring to FIG. 4e, another email form 430 for the creation of a new email is shown on the display 400. In this example as a starting point the user desires to address this new email to the previously-created group which had been assigned the name “MyFamily.” The user therefore enters the first few letters 431 of the group name in the recipient field 406. As the system recognizes and matches the first letters of the group name, the system automatically presents the user with a list of matching entries 432. As shown in FIG. 4f, once an entry is selected by the user, the system automatically completes the entry by displaying the full group name 428, “MyFamily,” in the recipient field 406, and the system additionally automatically populates the recipient field 406 with the five (5) email addresses 414, 416, 422 that are associated with that group. This action confirms to the user that the system has recognized the group name and has retrieved and entered the desired email addresses in the desired email field. (Alternatively, should the system not recognize the first few letters of the group name or should the system not be programmed with an automatic completion feature, then the system will wait until completion of the entry of the entire group name by the user before automatically populating the recipient field 406 with the email addresses.) At this point the user can complete any remaining uncompleted fields of the second email form 430 and then send the email to the recipients. (As previously mentioned, however, in alternative embodiments the presenting to the user of the group command and the creation of a group can occur after the email has been sent.)

Additionally, the system provides options to build upon or modify an existing group, or it can create additional groups that are based upon an existing group. Referring to FIG. 4g, the user has entered a sixth (6^{th}) email address 433 in the recipient field 406 so that it appears along with the email addresses that previously had been automatically entered and that comprise the previously-created group named “MyFamily.” In response to this inputting of the sixth email address 433, the system again automatically displays the first command icon 418 and the text entry box 420 without any additional command or action taken by the user. As soon as the first command icon 418 and the text entry box 420 are displayed, the user optionally can proceed with the creation of another group list that can be assigned a different group name in a manner that is similar to that described above. Alternatively the user can modify the existing “MyFamily” group by inputting the same group name in the text entry box 420 and selecting the first command icon 418 thereby increasing or decreasing the number of email addresses associated with the “MyFamily” group and/or substituting the email addresses associated with that group.

Referring now to FIG. 5, there is shown a simplified process flow diagram of a machine-implemented method for the automatic creation of an electronic message group in accordance with an embodiment of the invention. The process starts at step 502 after which a user starts a message creation process (Step 504) (such as for example being provided with an email message form) and awaiting a follow-up user action or input. (Step 506). Next the user inputs or otherwise selects a plurality of email addresses or a previously-generated group. (Step 508) Upon receipt by the system of a plurality of text characters or other data, the system automatically checks this input with any preexisting group names that are stored in a database. (Step 510) A determination is made whether a preexisting group exists that matches the text input. (Step 512) If there is a match, then the group name is displayed in the appropriate field of the email message form, and the associated addresses are populated into that field (Step 514), after which point the process returns to step 506 where the system awaits further user action or input. Returning to step 512, if on the other hand there is no match thus indicating that no pre-existing group exists, then a “group” command is displayed or otherwise presented to the user. (Step 516) Next a determination is made whether the user selects the “group” command. (Step 518) If it was not selected by the user, then the process returns to step 506 where the system awaits further user input. On the other hand if the “group” command was selected by the user, then in response to this selection the group is automatically created and stored in memory without any further command entered or action taken by the user. (Step 520)

In view of the above, it will be appreciated that embodiments of the invention overcome many of the long-standing problems in the art by providing a system, method and product for the automatic creation of groups, such as for example groups of electronic message recipient addresses. For example, the creation of a group can occur as an electronic message is being composed and with a single click of a mouse button or other single action by a user. Alternative embodiments relate to electronic message handling rules, the creation of which is dynamically based upon routine user actions or inputs that can have purposes other than only for the creation of rules. For example, upon the movement by a user of an email from one directory to any one of a plurality of other directories, the user is automatically provided with one or more rule creation options with different criteria that will automatically move other emails to that same directory if they meet the selected criteria.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A machine-implemented method for using electronic messages comprising:
providing a user with access to a recipient field of an electronic message;
receiving an input by the user of a plurality of addresses in the recipient field;
receiving a selection by the user of a group command after the inputting of the plurality of addresses, wherein the group command corresponds to a command to create an addressee group comprised of the plurality of addresses;
creating the addressee group in response to the selection by the user of the group command; and
storing the addressee group in a memory.

2. The method of claim 1 wherein the selection by the user of the group command is only a single action being performed by the user.

3. The method of claim 1 wherein the providing the user with access to the recipient field includes displaying on a user interface a form for composing the electronic message wherein the form includes the recipient field.

4. The method of claim 1 further comprising presenting the group command to the user in response to the inputting of the plurality of addresses in the recipient field.

5. The method of claim 4 wherein the presenting of the group command to the user includes one of:
activating on a display an icon associated with the group command, and
displaying on the display the icon associated with the group command, and
providing a machine-generated voice prompt associated with the group command.

6. A machine-implemented method for using electronic messages comprising:
providing a user with access to a first recipient field of a first electronic message;
receiving an input by the user of a plurality of addresses in the first recipient field;
receiving a selection by the user of a group command after the inputting of the plurality of addresses, wherein the group command corresponds to a command to create an addressee group comprised of the plurality of addresses;
receiving a first input by the user of a group name for the addressee group;
creating the addressee group in response to the selection by the user of the group command; and
storing the addressee group in a memory.

7. The method of claim 6 wherein the selection by the user of the group command is only a single action being performed by the user.

8. The method of claim 6 wherein providing the user with access to the first recipient field includes displaying on a user interface a first form for composing the first electronic message wherein the first form includes the first recipient field.

9. The method of claim 8 further comprising:
displaying on the user interface a second form for composing a second electronic message having a second recipient field;
receiving a second input by the user of the group name in the second recipient field; and
automatically inserting the plurality of addresses in the second recipient field in response to the second input by the user of the group name in the second recipient field.

10. The method of claim 6 further comprising presenting the group command to the user in response to the input by the user of the plurality of addresses in the first recipient field.

11. The method of claim 10 wherein the presenting of the group command to the user includes one of:
activating on a display an icon associated with the group command, and
displaying on the display the icon associated with the group command, and
providing a machine-generated voice prompt associated with the group command.

12. A machine for use by a user, the machine comprising:
a memory;
a processor coupled to the memory; and
an application stored in the memory and operable with the processor to process electronic messages by performing steps comprising:
providing a user with access to a first recipient field of a first electronic message;
receiving a plurality of addresses as inputted by the user in the first recipient field;
creating an addressee group comprised of the plurality of addresses in response to a selection by the user of a group command;
receiving a group name as entered by the user for the addressee group; and
storing the addressee group in a memory.

13. The machine of claim 12 wherein providing the user with access to the first recipient field includes displaying on a user interface a first form for composing the first electronic message wherein the first form includes the first recipient field.

14. The machine of claim 13 wherein the steps further comprise:
displaying on the user interface a second form for composing a second electronic message having a second recipient field;
receiving the group name as entered by the user in the second recipient field; and
automatically inserting the plurality of addresses in the second recipient field in response to the receiving of the group name in the second recipient field.

15. The machine of claim 12 wherein the steps further comprise presenting the group command to the user in response to the receiving of the plurality of addresses in the first recipient field.

16. A non-transitory, computer-readable storage medium for use by a user, wherein the storage medium contains instructions that, when executed by a processor, cause the processor to perform a method comprising:
providing a user with access to a first recipient field of a first electronic message;
receiving a plurality of addresses as inputted by the user in the first recipient field;
creating an addressee group comprised of the plurality of addresses in response to a selection by the user of a group command;
receiving a group name as entered by the user for the addressee group; and
storing the addressee group in a memory.

17. The storage medium of claim 16 wherein providing the user with access to the first recipient field includes displaying on a user interface a first form for composing the first electronic message wherein the first form includes the first recipient field.

18. The storage medium of claim 17 wherein the method further comprises:
displaying on the user interface a second form for composing a second electronic message having a second recipient field;
receiving the group name as entered by the user in the second recipient field; and
automatically inserting the plurality of addresses in the second recipient field in response to the receiving of the group name in the second recipient field.

19. The storage medium of claim 16 wherein the method further comprises presenting the first command to the user in response to the receiving of the plurality of addresses in the first recipient field.
